(19) United States
(12) Patent Application Publication
(10) Pub. No.: US 2002/0170940 A1
(43) Pub. Date: Nov. 21, 2002

(54) Welded tube manufacturing apparatus and welded tube internal surface bead cutting apparatus

(76) Inventors: Takashi Kazama, Kitakata-shi (JP); Kazunori Ozaki, Yama-gun (JP)

Correspondence Address: HARNESS, DICKEY & PIERCE, P.L.C., P.O. BOX 828, BLOOMFIELD HILLS, MI, 48303, US

(21) Appl. No.: 10/150,194

(22) Filed: May 17, 2002

(30) Foreign Application Priority Data
May 21, 2001 (JP) 2001-150663
May 21, 2001 (JP) 2001-150664
May 21, 2001 (JP) 2001-150668

(51) Int. Cl. B23K 31/02

(52) U.S. Cl. 228/144; 228/173.4; 228/173.5; 228/173.7

(57) ABSTRACT

This apparatus manufactures a welded tube by curling a metal strip T into a tube shape, heating the two edges thereof using an induction heating coil 6, and pressure welding the two edges using squeeze rolls 8. A ferrite core 21 for increasing heating efficiency that has a substantially circular arc shaped cross section is provided at a position on the top surface portion 25 of an impeder body 24 directly below the induction heating coil 6. A protective layer 29 formed from fluororesin is provided on the top surface of the impeder body and this protective layer catches spatter “c” generated during welding. The distal end of a cooling water supply tube 27 is embedded in a concave groove 26 in the impeder body 24 and the ferrite core 21 is cooled via a through passage 21a formed between the ferrite core 21 and a flat surface portion.

### BACKGROUND OF THE INVENTION

1. Field of the Invention

The present invention relates to a welded tube manufacturing apparatus that is provided with an impeder used when welding a metal tube, and to an internal surface bead cutting apparatus for cutting off an internal surface bead remaining on the welded portion of a welded tube.

2. Description of the Related Art

Electro-resistance-welded tubes that are used for hot water supply tubes and cold water supply tubes or for heat exchange tubes in air conditioners or refrigerators or the like are formed into a tube shape by curling a metal strip into a rounded shape as it is being fed along. The metal strip in this case being a belt of metal formed from copper or brass or the like. A tube is then formed by continuously welding both edges of the tube shaped material as it is fed along using a welding means provided by a high frequency dielectric welder or a high frequency resistance welder or the like. After weld bead portions remaining on the internal surface and external surface of the welded portions of the electro-resistance-welded tube have been removed by a cutting apparatus, the tube is shaped via a sizing process and is then cut into predetermined lengths.

An example of this type of electro-resistance-welded tube welding apparatus is disclosed in Japanese Patent Application Laid Open (JP-A) No. 8-99184. The apparatus described in this publication manufactures an electro-resistance-welded tube by curling a band of steel into a rounded shape and then welding the two edge portions thereof by high frequency induction welding. In this apparatus an impeder provided with an impeder core formed by a ferrite core or the like that increases the heating efficiency of welding during the electro-resistance-welded tube manufacturing process is inserted into the electro-resistance-welded tube.

Because the performance of the impeder core deteriorates if it is affected by heat, in the above apparatus a cooling water flow passage is provided inside the impeder core, which is formed in a tube shape, in order to cool the impeder core. In addition, a portion of the cooling water that has passed through the impeder core is sprayed from a jet aperture towards a position directly below the vicinity of the weld point in order to remove spatter generated during the welding that has splashed onto the internal surface of the electro-resistance-welded tube. The remaining cooling water is guided towards the distal end and sprayed in order to cool a cutting tool used for cutting off an internal surface bead that is mounted at the distal end of the impeder.

In the above described welding apparatus, the impeder core inserted into the electro-resistance-welded tube is formed as a circular cylinder and a tube body through which the cooling water is passed is fitted into this cylinder. A cutting tool for cutting off an internal surface bead is mounted on the distal end of the impeder core and cuts off an internal surface bead portion. In addition, a cooling water flow passage is formed between the circular cylindrical impeder core and the tube body for flushing out spatter generated during welding. As a result, the problem exists that the gross sectional area of the main impeder body, which is formed as a tube body, is reduced causing a drop in rigidity and a reduction in mechanical strength. Therefore, when an internal surface bead portion is cut off by the cutting tool provided at the distal end of the impeder, because the rigidity of the impeder body is small, chatter vibration and the like is generated leading to the problems of the precision of the cutting of the internal surface bead being insufficient and the life span of the impeder being shortened.

Moreover, even when an attempt is made to remove spatter generated during welding by spraying a jet of cooling water onto the area directly below the vicinity of the weld point, the spatter is scattered onto the metal impeder body, which it heats and becomes adhered to. Therefore, even if a jet of cooling water is sprayed onto the impeder body, the spatter cannot be satisfactorily removed and aggregates and hardens into an irregular lump. The spatter that has hardened into an irregular lump is flushed towards the distal end side causing problems when it becomes enmeshed with the blade of the cutting tool and cutting tool support members and the like and damages the internal surface of the electro-resistance-welded tube.

The spatter cannot be prevented from adhering to the impeder body by giving the impeder body a mirror finish.

Furthermore, in the above apparatus, rolls are provided that abut against internal tube surfaces both above and below a carriage that is fixed to a support member and is inserted into the electro-resistance-welded tube so that the rolls allow the electro-resistance-welded tube to be moved along. Above the top portion of the carriage the apparatus is also provided with a blade used for removing an internal surface bead that is mounted on a machine frame, and with a cutting machine for cutting a scraping of the cut bead into shorter pieces that is located directly below the blade.

When an internal surface bead is being cut off, a hydraulic cylinder provided inside the carriage is operated so that the machine frame supporting the blade is raised up. As a result, the blade is placed in contact with the internal surface bead and is able to cut off the bead. The scraping created by this is immediately cut into shorter pieces by the cutting machine placed directly below and these are moved along together with the electro-resistance-welded tube

In the above apparatus, when an electro-resistance-welded tube is manufactured by curling the metal strip into a C shape, heating it, passing it through squeeze rolls and welding it, there are cases when the welded portion is twisted so that the position of the internal surface bead shifts in the circumferential direction of the internal tube surface. In cases such as this, in the above apparatus, because the carriage on which the blade is provided is fixed to the support member by which it is supported and because the rolls are in contact with the internal surface of the electro-resistance-welded tube, if the internal surface bead shifts in the circumferential direction, the problem arises that the internal surface bead may not be able to be cut by the cutting blade.

### SUMMARY OF THE INVENTION

The welded tube manufacturing apparatus according to the first aspect of the present invention is an apparatus that manufactures an electro-resistance-welded tube by curling a metal strip into a tube shape and then pressure welding the two edges using squeeze rolls while heating the edges with a work coil. In this apparatus there is provided an impeder that has an impeder body in which there is an impeder core that is positioned directly below the work coil and increases heating efficiency. In the impeder core is formed a through passage through which cooling water passes.

According to this apparatus, by positioning the work coil directly above the impeder coil positioned in the impeder body, the heating efficiency of the work coil can be increased by the impeder core. Furthermore, by using the impeder core as a through passage and passing cooling water directly through this through passage, the impeder core can be directly and efficiently cooled and the welding heating efficiency of the work coil can be stabilized.

It is also possible for the through passage through which the cooling water passes to be formed between the impeder core and the top surface portion of the impeder body, which is the metal strip weld portion side thereof.

Because the impeder core is not provided below the impeder body, the cross sectional area of the impeder body can be enlarged by a corresponding amount enabling the rigidity and mechanical strength of the impeder to be improved. Moreover, by passing cooling water through the spatial through passage between the impeder core and the top surface portion of the impeder body, the impeder core can be efficiently cooled and the welding heating efficiency of the work coil can be stabilized.

It is also possible for the impeder core to have a substantially circular arc shaped cross section. In this case, by forming a substantially circular arc shaped outer peripheral configuration using the impeder core and the impeder body, the occupied area inside the electro-resistance-welded tube is enlarged enabling the cross sectional area of the spatial through passage to also be enlarged.

It is also possible for a cutting tool for removing an internal surface bead on an electro-resistance-welded tube to be mounted at the distal end side of the impeder. Because it is possible to guarantee sufficient rigidity and mechanical strength in the impeder even when a cutting tool is mounted on the distal end of the impeder and processing to cut off an internal surface bead is performed, there is no adverse effect on the processing by the cutting tool to cut off the internal surface bead. This enables precise processing to be performed without chatter vibration being generated during the cutting and thereby extends the life of the impeder.

The distal end side of the impeder refers to the front side in the direction in which the metal strip or electro-resistance-welded tube is transported.

It is also possible for a heat resistant coating membrane such as heat resistant tape to be used to cover the outer peripheral surface of the impeder core, thereby enabling the effects of heat on the impeder core to be suppressed even further.

It is also possible for a highly heat resistant protective layer formed from a non-metallic material to be provided on the impeder at a position below the weld portion of the two edges of the metal strip so that spatter generated during welding is caught by the protective layer. In addition, cooling water passing through the impeder core can be supplied to the spatter fall surface on the impeder. It is also possible for a highly heat resistant protective layer formed from a non-metallic material to be provided on this spatter fall surface.

During welding, when the impeder core is heated and is thermally expanded, the resistance thereof changes and the heating efficiency of the work coil changes. However, by passing cooling water through the impeder core, the impeder core can be cooled and changes in the characteristics thereof suppressed. Moreover, by then discharging this cooling water onto the spatter fall surface or the protective layer, the scattered spatter can be flushed away while still in a powder state before it hardens into a solid lump.

If the spatter is caught by the protective layer and cooling water is supplied to the protective layer, then even if flying spatter reaches the protective layer the spatter can be flushed away and removed from the protective layer while still in a powder state before it hardens into a solid lump and adheres to the protective layer. Even if hardened spatter is flushed towards the cutting tool, because it is in a powder state, it can be prevented from becoming enmeshed with the cutting blade of the cutting tool and the support member and thereby abrading the internal wall surface of the electro-resistance-welded tube or damaging the cutting blade. As a result, the product quality of the internal surface of the electro-resistance-welded tube can be improved.

The welded tube manufacturing apparatus according to the second aspect of the present invention is an apparatus that manufactures an electro-resistance-welded tube by curling a metal strip into a tube shape and then pressure welding the two edges using squeeze rolls while heating the edges with a work coil. In this apparatus a highly heat resistant protective layer formed from a non-metallic material is provided on the impeder at a position below the weld portion of the two edges of the metal strip so that spatter generated during welding is caught by the protective layer.

By catching the spatter on the protective layer, the adhering and hardening of spatter on the impeder surface can be suppressed and the smooth removal of the spatter can be encouraged.

The protective layer may be formed from fluororesin.

Because fluororesin is a non-metallic material and has extremely good resistance to heat and electrical insulation properties, and is also extremely water repellant and has low adhesion and a low coefficient of friction, it is possible to prevent spatter scattered from the weld portion from adhering to the metal impeder and accelerate the smooth removal of the spatter.

It is also possible to supply cooling water to the protective layer on the impeder to remove spatter. By supplying cooling water to the protective layer, even if flying spatter reaches the protective layer the spatter can be flushed away and removed from the protective layer while still in a powder state before it hardens into a solid lump and adheres to the protective layer. Therefore, even if hardened spatter is flushed towards the cutting tool, because it is in a powder state, it can be prevented from becoming enmeshed with the cutting blade of the cutting tool and the support member and thereby abrading the internal wall surface of the electro-resistance-welded tube or damaging the cutting blade. As a result, the product quality of the internal surface of the electro-resistance-welded tube can be improved.

The impeder may also be provided with an impeder core that is positioned directly below the work coil and increases heating efficiency, and for cooling water to be discharged onto the protective layer on the impeder through the impeder core.

During welding, when the impeder core is heated and is thermally expanded, the resistance thereof changes and the heating efficiency of the work coil changes. However, by passing cooling water through the impeder core, the impeder core can be cooled and changes in the characteristics thereof suppressed. Moreover, by then discharging this cooling water onto the protective layer, spatter that has been scattered onto the protective layer can be flushed away while still in a powder state before it hardens into a solid lump.

It is also possible for an impeder having an impeder core on a top surface portion of an impeder body to be provided, and for a through passage through which cooling water is passed to be formed between the impeder core and the top surface portion of the impeder body. In this case, the heating efficiency of the work coil can be improved using the impeder core positioned directly below the work coil. Moreover, because the impeder core is not positioned below the impeder body, the cross sectional area of the impeder body can be enlarged by a corresponding amount enabling the rigidity and mechanical strength of the impeder to be improved. Moreover, by passing cooling water through the through passage between the impeder core and the top surface portion of the impeder body, the impeder core can be directly and efficiently cooled with the cooling water then discharged onto the protective layer, and the welding heating efficiency of the work coil can be stabilized.

It is also possible for the impeder core to have a substantially circular arc shaped cross section.

By forming a substantially circular arc shaped outer peripheral configuration using the impeder core and the impeder body, the occupied area inside the electro-resistance-welded tube is enlarged enabling the cross sectional area of the through passage to also be enlarged.

It is also possible for a cutting tool for removing an internal surface bead on an electro-resistance-welded tube to be mounted at the distal end side of the impeder.

Because it is possible to guarantee sufficient rigidity and mechanical strength in the impeder even when a cutting tool is mounted on the distal end of the impeder and processing to cut off an internal surface bead is performed, there is no adverse effect on the processing by the cutting tool to cut off the internal surface bead. This enables precise processing to be performed without chatter vibration being generated during the cutting and thereby extends the life of the impeder.

It is also possible for a heat resistant coating membrane such as heat resistant tape to be used to cover the outer peripheral surface of the impeder core, thereby enabling the effects of heat on the impeder core to be even further suppressed.

The welded tube internal bead cutting apparatus according to the third aspect of the present invention is an apparatus that cuts off an internal surface bead on an electro-resistance-welded tube using a cutting blade of a cutting tool that is inserted into the electro-resistance-welded tube, in which the cutting tool is supported in a manner whereby the cutting tool is able to rotate substantially around a central axis of the electro-resistance-welded tube.

Even if the internal surface bead in the electro-resistance-welded tube is shifted slightly in the circumferential direction as a result of the welding, by adjusting the cutting tool so that it is slightly rotated substantially around the central axis of the electro-resistance-welded tube, the position of the cutting blade in the circumferential direction can also be adjusted by being rotated along the internal surface of the tube. As a result, the cutting blade can reliably cut into and remove the internal surface bead.

It is also possible for the cutting blade to be disposed so as to face towards the rear relative to the direction in which the electro-resistance-welded tube is transported, and to be formed substantially in a circular arc shape running in the electro-resistance-welded tube inner surface circumferential direction.

When the cutting blade is adjusted by being rotated along the inner surface of the tube to match the shift in the internal surface bead, because the cutting blade is formed with a substantially circular arc configuration, the cutting blade can be reliably rotated along the internal surface of the tube without abrading the internal surface, enabling the cutting blade to be abutted against the internal surface bead.

It is also possible for the cutting tool to be supported by a support member, and for the cutting tool to be able to be rotated around the central axis of the electro-resistance-welded tube by the rotation of the support member.

If a support member is disposed at a position towards the rear of the electro-resistance-welded tube and before the weld, the position of the cutting blade of the cutting tool can be adjusted from outside the electro-resistance-welded tube.

### BRIEF DESCRIPTION OF THE DRAWINGS

FIG. 1 is a schematic view showing a welded tube manufacturing apparatus according to an embodiment of the present invention.

FIG. 2 is a schematic view showing an impeder used in the manufacturing apparatus shown in FIG. 1.

FIG. 3 is an enlarged view of the main portions of the impeder shown in FIG. 2.

FIG. 4 is a cross sectional view taken along the line A-A of the impeder shown in FIG. 3.

FIG. 5 is a cross sectional view taken along the line B-B of the impeder shown in FIG. 3.

FIG. 6 is a schematic view showing a state in which an internal surface bead in an electro-resistance-welded tube is being cut by a cutting tool connected to an impeder holder in another embodiment of the present invention.

FIG. 7 is a schematic view showing a positional relationship between an impeder holder and squeeze rolls and the like.

FIG. 8 is an explanatory view showing a relationship between a metal strip that has been formed into a C shape, a cutting tool, and an impeder holder.

FIG. 9 is an explanatory view showing a relationship between an electro-resistance-welded tube, a cutting tool, and an impeder holder.

### DESCRIPTION OF THE PREFERRED EMBODIMENTS

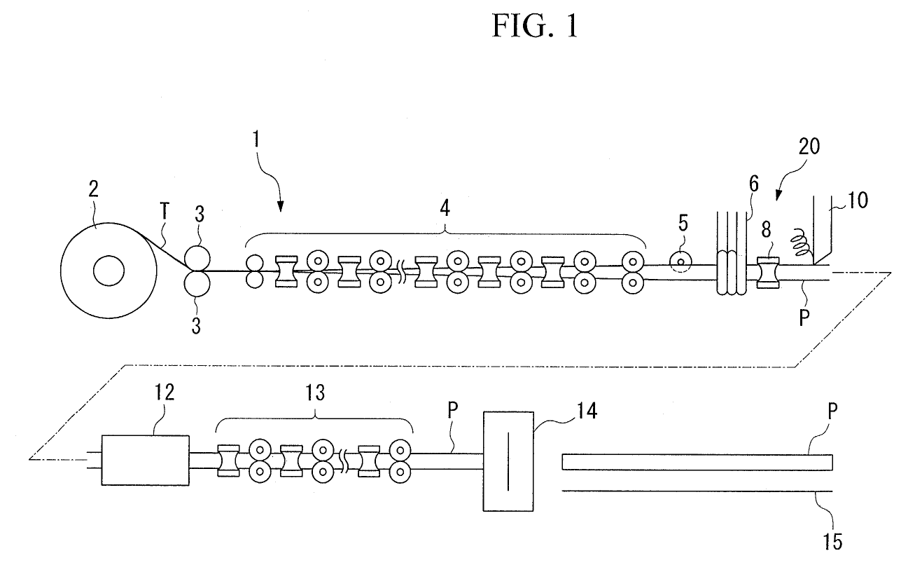

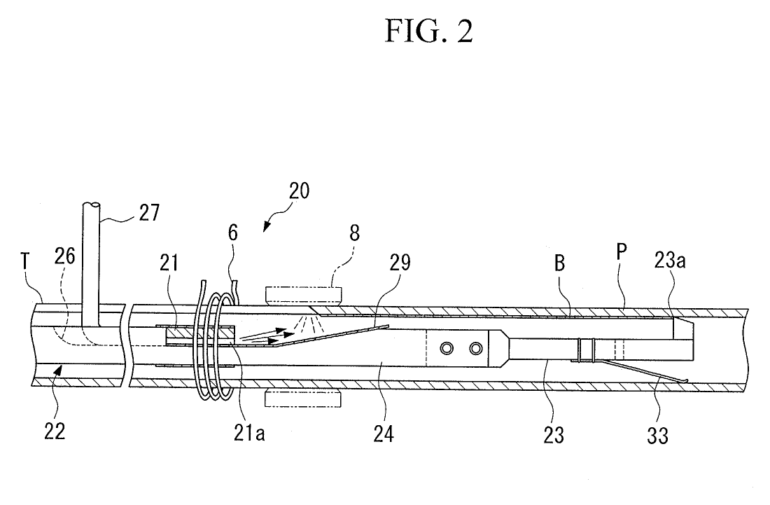

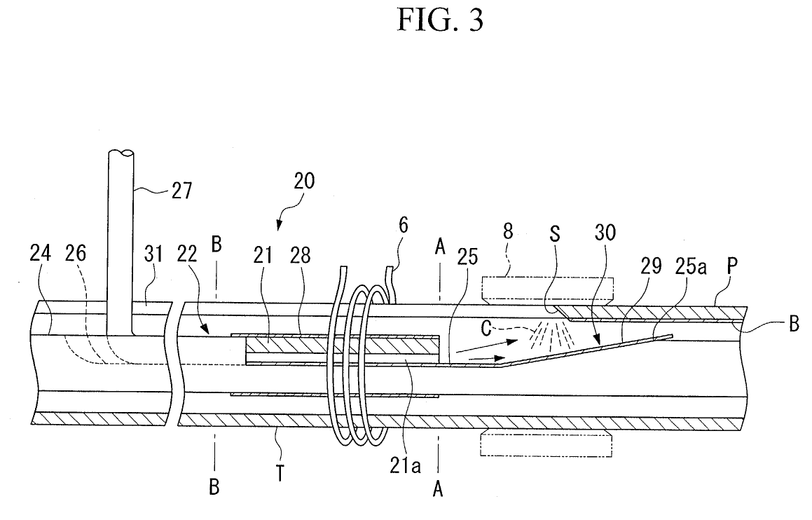

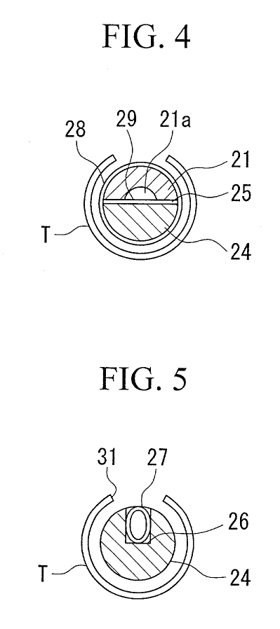

Embodiments of the present invention will now be described with reference made to FIGS. 1 through 5. FIG. 1 is a schematic view showing a production line for a welded tube manufacturing apparatus. FIG. 2 is a schematic view showing an impeder used in the manufacturing apparatus shown in FIG. 1. FIG. 3 is an enlarged view of portions of the impeder shown in FIG. 2. FIG. 4 is a cross sectional view taken along the line A-A in FIG. 3. FIG. 5 is a cross sectional view taken along the line B-B in FIG. 3.

An electro-resistance-welded tube according to an embodiment of the present invention is a simple metal tube having a smooth internal surface and is used, for example, as a hot water supply tube, a cold water supply tube, or the like, however, the present invention may also be applied to any metal tube such as a metal tube that has irregular structures formed on the external surface of the tube or that has grooves formed on the internal surface of the tube and is used in refrigerators or air-conditioning equipment or the like. Moreover, the material from which the electro-resistance-welded tube according to the present embodiment is formed is brass, however, the present invention may also be applied to copper tubes, aluminum tubes, or metal tubes formed from some other material.

In the manufacturing apparatus 1 for manufacturing an electro-resistance-welded tube (referred to below simply as a “tube”) shown in FIG. 1, a metal strip T in the form of a continuous belt having a constant width that is formed from a belt of metal such as brass is continuously fed out from an uncoiler 2. The fed out metal strip T passes through a pair of pressing rolls 3 and then through a plurality of pairs of forming rolls 4 arranged in a row. The metal strip T is thus gradually curled into the shape of a C. Once the amount of the gap between the two edges of the metal strip T that are to be butted together is made uniform by a rolling separator 5, the metal strip T is passed through a work coil of an induction heating section, for example, through an induction heating coil 6.

The induction heating coil 6 is formed by winding a wire or hollow metal tube around several times to form a spiral that heats the metal strip T that has been curled into a C shape and generates joule heat that is concentrated in both edges. When the metal strip T that has been heated by the induction heating coil 6 passes through a pair of squeeze rolls 8 and 8 the two heated edges are pressed so as to be butted together and are then welded. On the internal and external surfaces of the electro-resistance-welded tube P formed by the welding of the metal strip T, internal and external surface beads are formed from fused material extruded from the welded portion.

The external surface bead is cut off and removed by a cutting apparatus 10 and the internal surface bead is also cut off and removed by a cutting tool described below. After the tube P has passed through a cooling tank 12 and been forcibly cooled, it is shrunk to a predetermined external diameter by being passed through a plurality of pairs of sizing rolls 13 arranged in a row. After the tube P has been shaped by a shaping roller (not shown) it is cut into predetermined lengths, for example, 4 to 6 mm by a cutting apparatus 14 and the cut tubes are then stacked on a stock table 15.

A detailed description will now be given using FIGS. 2 through 5 of a welding apparatus that includes the impeder according to the present embodiment in the welded tube manufacturing apparatus 1 having the above described schematic structure.

As is shown in FIGS. 2 and 3, the welding apparatus 20 according to the present embodiment is provided with an induction heating coil 6 for heating a metal strip T that has been curled by a forming roller 4 and in which the amount of gap between the two edges of the metal strip T is kept constant by a rolling separator 5; squeeze rolls 8 and 8 that pressure weld the two edges of the metal strip T that has been curled into a C shape; an impeder core, for example, a ferrite core 21 that increases the heating efficiency of the induction heating coil 6; and an impeder 22 on which the ferrite core is mounted.

The impeder 22 of the present embodiment is shaped substantially as a rod and, as is shown in FIG. 2, is inserted into the sheet shaped member T that has been curled into a C shape extending into the tube P that is formed when the two edges of the sheet shaped member T are welded. A cutting tool 23 for cutting off an internal surface bead B inside the tube P is mounted at a distal end of the impeder 22, namely, at the distal end in the direction in which the tube P is transported. A cutting blade 23a of the cutting tool 23 faces towards the rear in the transportation direction of the tube P. A support member 33 having elasticity is provided for the cutting tool 23 on the opposite side from the cutting blade 23a and in contact with the inner wall of the tube P. The support member 33 presses the cutting blade 23a against the internal wall bead portion B.

The impeder 22 shown in FIGS. 2 and 3 is provided with, for example, a metal substantially rod shaped or substantially circular cylinder shaped impeder body 24. In the vicinity of that area of the impeder body 24 where a welding apparatus 20 is provided for the metal strip T (and the tube P), as is shown in FIG. 4, the top portion of the impeder body 24, which is the portion thereof that is on the side of the weld portion in the metal strip, is cut so as to have a substantially semicircular cross section, and thereby form, for example, a top surface portion 25 having a substantially flat surface. The distal end side of this top surface portion 25 is formed as an inclined surface 25a that climbs towards the distal end, while in the rear end portion continuing onto the top surface portion 25 is formed a concave groove 26 that extends towards the rear end side.

On the top surface portion 25 in the area directly below the induction heating coil 6 is mounted a ferrite core that has a substantially circular arc shaped cross section and extends from the rear end of the top surface portion 25 towards the front. A through passage 21a having a substantially semicircular cross section is formed by the ferrite core 21 and the top surface portion 25. Heat resistant tape 28 covers the entire circumference of the external surface that is shaped substantially as a circular cylinder of the ferrite core 21 and the impeder body 24 in the vicinity of the ferrite core 21 so as to provide a heat resistant coating film. The top surface portion 25 in the front of the ferrite core 21 and the inclined surface 25a extend as a spatter fall surface 30 that is positioned below the weld portion S of the tube P that is sandwiched by the pair of squeeze rolls 8 and 8.

For example, as is shown in FIG. 5, a cooling water supply tube 27 made from copper, for example, may be fitted into the concave groove 26 on the rear end side of the ferrite core 21. The distal end of this cooling water supply tube 27 communicates with the through passage 21a bounded by the ferrite core 21 and the top surface portion 25 while the rear portion side thereof extends towards the rear of the concave groove 26 and is bent partway along so that it stands extending upwards. The cooling water supply tube 27 is connected to an external cooling water supply source (not shown) via a gap 31 in the metal strip T that has been curled into a C shape.

As a result, cooling water supplied from the cooling water supply tube 27 passes through the through passage 21a of the ferrite core 21 and is discharged to the spatter fall surface 30 formed by the front part of the top surface portion 25 and the inclined surface 25a.

A protective layer 29 formed as a thin membrane from a non-metallic material that has excellent heat resistance and electrical insulation as well as excellent water repellency covers the entire top surface portion 25 of the impeder body 24 where the ferrite core is mounted extending over the inclined surface 25a. The protective layer 29 is characterized in that it is difficult for spatter c generated at the weld portion S to adhere to it, and is preferably formed by a resin layer, and more preferably by a fluororesin layer such as polyvinylidene fluoride or polytetrafluoroethylene. In addition to the above features, a fluororesin layer has a low coefficient of friction and tackiness and shows excellent properties in preventing spatter c generated at the weld portion S from adhering to it.

The method of welding an electro-resistance-welded tube P will now be described.

Firstly, a metal strip T is curled into a C shape by being passed through the forming rolls 4. Once the amount of the gap between the two edges of the metal strip T that are to be butted together is made constant by a rolling separator 5, the metal strip T is passed through the induction heating coil 6. Both edges of the metal strip T that has been curled into a C shape are heated by an induction current generated when a high frequency wave or medium frequency wave current, for example, is passed through the induction heating coil 6. Moreover, by controlling the impedance using the ferrite core 21 on the impeder 22 positioned directly below the induction heating coil 6, the induction current can be concentrated on the two edges of the metal strip so as to generate concentrated joule heat and improve welding efficiency.

In the metal strip T that has passed through the induction heating coil 6, the two edges thereof that were heated as they passed between the squeeze rolls 8 and 8 are pressed and butted together and then welded.

When the ferrite core 21 is heated during the heat welding the resistance value thereof changes, however, because cooling water is supplied via the cooling water supply tube 27 to the ferrite core 21 via the through passage 21a between the ferrite core 21 and the top surface portion 25 of the impeder body 24, the ferrite core 21 is directly and efficiently cooled, enabling heat generation and thermal expansion to be suppressed and also enabling changes in characteristics that accompany heating to be suppressed.

When the two edges of the metal strip T that has been curled into a C shape are butted together by the pair of squeeze rolls 8 and 8 and welded, spatter c is generated at the weld portion S and is scattered inside the tube P. In this case, if the material of the metal strip T is brass, more spatter c is generated at the weld portion S than is generated when other materials are used.

The majority of the spatter c that is scattered inside the tube P falls onto the spatter fall surface 30 formed by the top surface portion 25 directly below the weld portion S and the inclined surface 25a that are located away from the ferrite core 21. However, the tops of the top surface portion 25 and the inclined surface 25a are covered by the protective layer 29, and before spatter c that falls onto the protective layer 29 is able to adhere to the protective layer 29 and harden, it is flushed to the front of the tube P while still in a powder state by a jet of cooling water sprayed onto the protective layer 29 via the through passage 21 of the ferrite core 21.

Because the cooling water is discharged onto the protective layer 29 with the water flow having been concentrated as a result of passing through the through passage 21a, which has a substantially semicircular cross section, of the ferrite core 21, and because the protective layer 29 is formed from fluororesin and thus has a high level of water repellency, the speed of flow of the cooling water can be kept high. Therefore, spatter c can be prevented from adhering and hardening into a solid lump on the inclined surface 25a and the top surface portion 25 of the impeder body 24, which is a metal surface, and can be flushed forward while still in a powder state together with the cooling water.

Accordingly, there is no hardening of spatter into a solid lump that becomes enmeshed with the cutting blade 23a of the internal surface bead portion cutting tool 23 or with the cutting tool support member and the like and thereby abrades the internal wall surface of the tube P or damages the cutting blade 23a. Neither is there any adhering of spatter to the impeder body 24 resulting in the flow of cooling water being obstructed and damage being caused to the internal wall of the tube P and impeder 22.

As has been described above, according to the present embodiment, by forming the ferrite core 21 with a cross section substantially in the shape of a circular arc in contrast to a conventional ferrite core that has a cross section substantially in the shape of a circular cylinder and providing the ferrite core only on the top surface portion 25 of the impeder body 24, the occupied cross sectional area inside the tube P is reduced allowing the cross sectional area of the impeder body 24 to be increased by the same amount. Accordingly, the holding strength by which the cutting tool 23 that is mounted on the distal end of the impeder body 24 and is used for cutting an internal bead portion is held is increased, and the cutting processing to cut the internal surface bead portion B is not adversely affected. Moreover, because the ferrite core 21 is positioned adjacent to the area directly below the induction heating coil 6, there is no reduction in the increase in the heating efficiency of the coil 6, and cooling water can be efficiently supplied so that the resistance characteristics of the ferrite core 21 do not change.

Furthermore, because the protective layer 29 that is highly resistant to heat and has high electrical insulation and the like is provided on the spatter fall surface 30 of the impeder 24 onto which spatter c falls from the weld portion S, spatter c can be flushed by cooling water from the protective layer 29 while still in a powder state before it hardens into a solid lump, the spatter c can be prevented from adhering and hardening on the impeder body 24, and lumps of spatter c can be prevented from becoming enmeshed with the cutting blade 23a of the cutting tool 23 and the like and thereby abrading the internal wall surface of the tube P or damaging the cutting blade 23a.

In the above described embodiment the ferrite core is formed with a cross section shaped substantially as a circular arc (i.e., in the shape of a circular cylinder that has been cut in half), however, the shape of the cross section of the ferrite core 21 is not limited to this. It is also possible for the cross section of the ferrite core 21 to be formed in an upright U shape or in a horizontal ⊃ shape, or for the ferrite core to be formed in a plate shape with the top surface portion 25 formed as a concave curved surface. Namely, provided that a through passage 21a is formed that allows cooling water to pass between the top surface portion 25 of the impeder body 24 and the ferrite core 21, then any suitable cross sectional configuration can be employed. It is also possible for the ferrite core 21 to be formed as a small circular cylinder that is placed on the top surface portion 25 and for the ferrite core 21 to be used as the through passage 21a.

Moreover, in the present embodiment a ferrite core 21 is used as the impeder core, however, the present embodiment is not limited to this and provided that the heating efficiency of the induction heating coil 6 is increased, then the impeder core may be formed from another material such as, for example, silicon steel plate.

In the above described embodiment, the cutting tool is provided at the distal end of the impeder 22, however, the present embodiment is not limited to this and the impeder and cutting tool may be provided as separate objects.

(Second Embodiment)

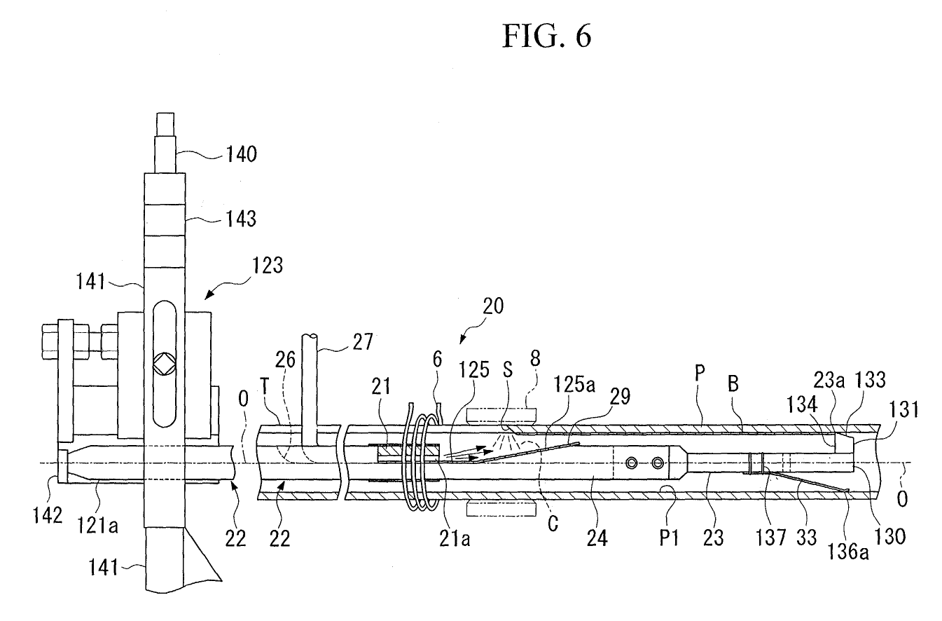

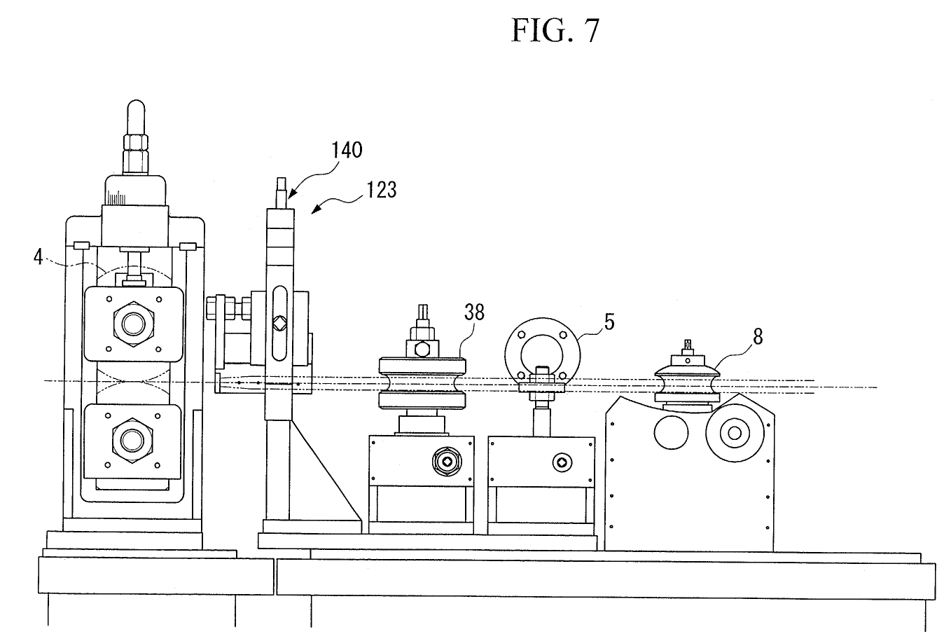

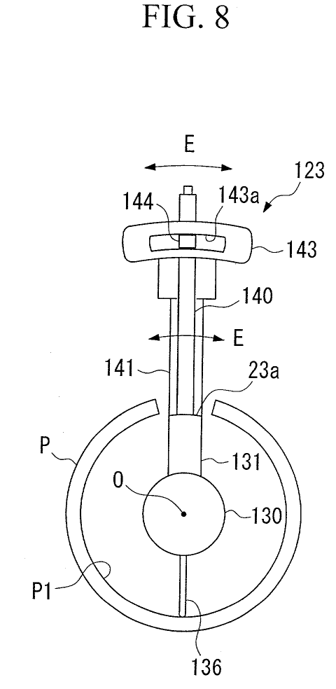

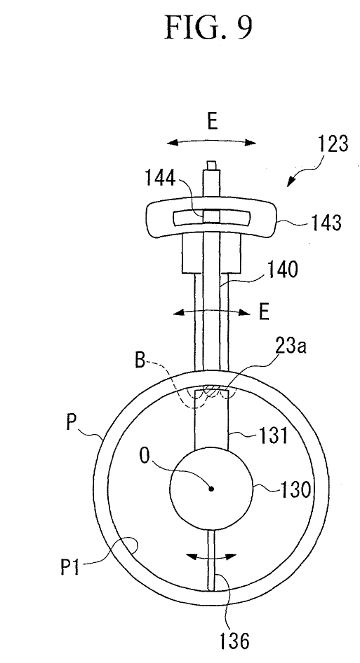

The second embodiment of the present invention has the same schematic structure as that shown in FIG. 1 and a description of those component elements that are common to the first embodiment is omitted. The main features of the second embodiment are in the structure shown in FIGS. 6 to 9. FIG. 6 is a schematic view showing an impeder holder, impeder, and cutting tool. FIG. 7 is a side view showing a positional relationship between an impeder holder and squeeze rolls. FIG. 8 is an explanatory view showing an impeder holder and a cutting tool from the front. FIG. 9 is an explanatory view showing an impeder holder, a cutting tool and an electro-resistance-welded tube from the front.

As is shown in FIG. 6, in the cutting apparatus 20 a cutting tool 23 for cutting off an internal surface bead B inside the tube P is mounted at a distal end of an impeder 22 that is used for welding, namely, at the front in the direction in which the tube P is transported. At the rear end of the impeder 22 there is provided an impeder holder 123 that is fixed to the impeder 22 and stands substantially vertically upright. The impeder holder 123 and the cutting tool 23 are connected together so as to have substantially the same center axis O. This center axis O preferably also matches the center axis of the electro-resistance-welded tube P.

As is shown in FIG. 6, the impeder 22 is inserted into the sheet shaped member T that has been curled into a C shape extending into the tube P that is formed when the two edges of the sheet shaped member T are welded together. The top portion of the impeder body 24 of the impeder 22 is cut off in the vicinity of a weld portion S in the metal strip T so that, for example, a substantially flat top surface portion 125 is formed. The distal end side thereof is formed by an inclined surface 125a that rises gradually upwards.

A ferrite core 21 having a substantially circular arc shaped cross section is mounted above the upper surface portion 125 in the area directly beneath the induction heating coil 6. A spatial through passage 21a is formed by the ferrite core 21 and the upper surface portion 25. The spatial through passage 21a is connected to the distal end of a cooling water supply tube 27 for supplying cooling water. Cooling water is thus supplied to a spatter fall surface formed by the top surface portion 125 in front of the open passage 21a and the inclined surface 125a. Above the spatter fall surface is positioned the weld portion S, which is sandwiched by the pair of squeeze rolls 8 and 8. If the material of the metal strip T is brass, more spatter c is generated at the weld portion S than is generated when other materials are used. The same protective layer 29 that was described in the first embodiment is formed on the spatter fall surface.

The cutting tool 23 is supported at the distal end of the impeder body 24. A blade tip portion 131 protruding outwards in a diametrical direction is provided at the distal end of the cutting tool body 130 formed substantially in a rod shape, namely, at the forward end in the transport direction of the tube P. A cutting blade 23a is provided at an outer side end portion in the diametrical direction of the blade tip portion 131 facing in the direction of the impeder 22.

The cutting blade 23a cuts off an internal surface bead B on the tube P by cutting into the internal surface bead B and is formed substantially in a circular arc shape running in the circumferential direction of the internal surface P1 of the tube P (see FIGS. 8 and 9). A flank 133 of the cutting blade 23a is formed as a substantially convex curved surface and has a positive clearance angle, while a face 134 also has a positive rake angle. In addition, the face 134 is formed as a convex or concave curved surface or as a flat surface that inclines towards the front in a direction extending from one end to the other end of the cutting blade 23a so that a scraping created by the cutting blade 23a is made to curl by the face 134 in a helical shape and sent towards the distal end.

A spring member 33 having, for example, either a linear or plate configuration is provided on the opposite side from the cutting blade 23a of the cutting tool body 130. The spring member 33 is fixed by a fixing member 137 at a partway position in the longitudinal direction of the cutting tool body 130. As a result of a curved portion 136a at the distal end of the spring member 33 that gradually moves away from the cutting tool body 130 towards the distal end side being in contact with the internal surface P1 of the tube P, the cutting blade 23a is made to abut against the internal surface bead B by the elastic force thereby created.

As is shown in FIG. 7, the impeder holder 123 fixed to the rear end of the impeder 22 is positioned, for example, to the rear of the squeeze rolls 8, the rolling separator 5, and the side rolls 38 and in front of the forming roller 4. Therefore, the impeder 22 extends from the rear end of the cutting tool 23 to the position of the impeder holder 123 and the metal strip T that has passed through the forming rolls 4 is changed into a C shape in this area so that at least the top thereof is left open.

The base portion 121a of the impeder 22 is linked to a shaft body 140 of the impeder holder 123. In addition, the rear end of the base portion 121a is rotatably supported by a bearing 142 of a holder body 141 positioned to the rear of the shaft body 140. The shaft body 140 extends upwards in an upright direction relative to the metal strip T that has been curled into a C shape from the fixed portion where the shaft body 140 is fixed to the impeder holder 123, and is supported so as to be able to rotate around the centrals axis O of the impeder 22.

A guide portion 143 having a substantially circular arc configuration is formed on the top portion of the holder body 141 so as to be substantially linearly symmetrical relative to the shaft body 140. A sliding groove 143a having a substantially circular arc configuration is formed inside the guide portion 143. A protruding portion 144 is formed protruding at the top of the shaft body 140 and this protruding portion 144 is able to fit slidably into the sliding groove 143a of the guide portion 143.

When the shaft body 140 is rotated in a direction E (i.e., to the left and right) within a plane that is substantially orthogonal to the transport direction of the metal strip T in FIGS. 8 and 9, the protruding portion 144 slides in the E direction along the sliding groove 143a of the guide portion 143 enabling the rotation of the shaft body 144 to be guided. As a result, the shaft body 144 is rotated substantially around the central axis O of the impeder 22 and the cutting tool 23. Because the rear end of the base portion 121a of the impeder 22 is rotatably supported by the bearing 142, the bearing 142 becomes the center of rotation of the shaft body 140 via the impeder 22, and the impeder 22 and the cutting tool 23 rotate around the central axis O.

The impeder 22 and the cutting tool 23 are positioned so that simultaneously the central axis O thereof is substantially the central axis of the electro-resistance-welded tube P. Therefore, as the shaft body 140 is rotated, the cutting blade 23a of the cutting tool 23 is rotated in a circumferential direction substantially around the central axis O along the internal surface P1 of the tube P.

The operation will now be described. When the metal strip T is curled into a C shape by passing through the forming rolls 4 and then passes between the pair of squeeze rolls 8 and 8 via the induction heating coil 6, the two heated edges are pressed and butted together and then welded. At this time, spatter c is generated at the weld portion S and is scattered into the tube P. This spatter c falls onto the inclined surface 125a and the top surface portion 125 of the impeder body 24.

The spatter c that falls on the top surface portion 125 and the inclined surface 125a is flushed by a jet of cooling water sprayed through the spatial through passage 21a of the ferrite core 21 forwards in the transport direction of the tube P. Internal and external surface beads are formed at the weld portion S when the tube P is welded, and the external surface bead is cut off by the cutting apparatus 10.

The internal surface bead B is cut off by the cutting blade 23a of the cutting tool 23 that is supported at the distal end of the impeder 22 as the welded tube P is being transported forward.

When the cutting blade 23a of the cutting tool 23 is cutting into the internal surface bead B due to the urging force of the spring member 33, the internal surface bead B is cut off at a predetermined cutting depth, and the scraping that is thereby created is sent forward together with the electro-resistance-welded tube P while being curled by the face 134.

When the metal strip T that has been curled into a C shape and transported forward, and has then passed through the induction heating coil 6 and the ferrite core 21 is having the two edges thereof heat welded by the squeeze rolls 8 and 8, in some cases the weld portion S twists causing the electro-resistance-welded tube P to twist slightly in the circumferential direction. In such cases, if an attempt is made to cut off the internal surface bead B of the electro-resistance-welded tube P while it is in such a state, the internal surface bead B shifts slightly in the circumferential direction from the cutting blade 23a of the cutting tool 23 resulting in it not being possible to remove the internal surface bead B satisfactorily.

In cases such as this, the angle of the impeder 22 and cutting tool 23 is adjusted by slightly rotating the shaft body 140 of the impeder holder 123. Namely, if the shaft body 140 is rotated a minute distance in the E direction, because the protruding portion 144 rotates in a substantially circular arc configuration while being guided in the sliding groove 143a of the guide portion 143, the shaft body 140 rotates integrally with the impeder 22 around the central axis O of the impeder 22. Moreover, because the impeder 22 rotates with the rear end of base portion 121a thereof supported in the bearing 142, the impeder 22 and the cutting tool 23 are rotated a minute angle around the central axis O of the tube P.

As a result of this, because the cutting blade 23a of the cutting tool 23 is also rotated around the central shaft O, the cutting blade 23a is rotated a slight angle along the inner periphery of the internal surface P1 of the tube P and it is possible to rotate the cutting blade 23a to a completely different position from the internal surface bead B. At this time, because the spring member 33 of the cutting tool 23 that is on the opposite side from the cutting blade 23a relative to the central axis O is also rotated in the same way in the circumferential direction with the curved portion 136a of the distal end thereof sliding along the internal surface P1, the cutting blade 23a is able to cut into and remove the internal surface bead B to a predetermined depth using the elastic force of the spring member 33 even in the new position to which the cutting blade 23a has been rotated.

The adjustment of the position of the cutting blade 23a through the rotation of the impeder holder may be performed with the transporting of the metal strip T having been stopped, or it may be performed while the metal strip T is still being transported.

As has been described above, according to the present embodiment, even if a weld portion S is twisted during the welding of a moving metal strip T and the tube P is thereby twisted causing the position of the internal surface bead B to shift in the circumferential direction, by slightly rotating the shaft body 140 of the impeder holder 123 around the central axis O of the tube P, it is possible to finely adjust the position of the cutting blade 23a of the cutting tool 23 in the circumferential direction from outside the tube P, and reliably cut off the internal surface bead B.

In the above described embodiment, a structure is employed in which the impeder holder 123 is linked to the cutting tool 23 via the impeder 22, however, the present embodiment is not limited to this and it is also possible to link the impeder holder 123 directly to the cutting tool 23. The impeder holder 123 forms a support member.

The cutting tool 23 may be attached to the impeder in a manner whereby the cutting blade 23a is able to swing between a direction in which it cuts into the internal surface bead B and a direction in which it moves away from the internal surface bead B. In this case, the cutting tool 23 is shifted away from the central axis O of the impeder 22 and the tube P. In this case as well, because the cutting tool 23 turns around the central axis O, in the same way as in the present embodiment, the position of the cutting blade 23a can be finely adjusted in the circumferential direction.

What is claimed is:

1. A welded tube manufacturing apparatus, comprising:
forming rolls which curl a metal strip into a tube shape;
a work coil which heats both edges of the curled metal strip;
squeeze rolls which press and weld the two heated edges; and
an impeder,
wherein the impeder is provided with an impeder core that is positioned directly below the work coil and increases heating efficiency, an impeder body that supports the impeder core, and a cooling water passage through which cooling water passes while cooling the impeder core.

2. A welded tube manufacturing apparatus according to claim 1, wherein the cooling water passage is formed between the impeder core and a top surface portion of the impeder body facing a metal strip weld portion.

3. A welded tube manufacturing apparatus according to claim 1, wherein the impeder core has a substantially circular arc shaped cross section.

4. A welded tube manufacturing apparatus, comprising:
forming rolls which curl a plate shaped material into a tube shape;
a work coil which heats both edges of the curled plate shaped material;
squeeze rolls which press and weld the two heated edges; and
an impeder,
wherein the impeder is provided with a heat resistant protective layer formed from a non-metallic material that is positioned below the weld portion of the two edges of the metal strip so that spatter generated during welding is caught by the protective layer.

5. A welded tube manufacturing apparatus according to claim 4, wherein the protective layer is formed from fluororesin.

6. A welded tube manufacturing apparatus according to claim 4, wherein there is further provided a cooling water supply mechanism which supplies cooling water to the protective layer so as to remove the spatter.

7. A welded tube manufacturing apparatus according to claim 4, wherein the impeder is provided with an impeder core that is positioned directly below the work coil and increases heating efficiency; and in the impeder core is formed a cooling water passage through which cooling water is supplied to the protective layer.

8. A welded tube internal bead cutting apparatus comprising:
a cutting tool to be inserted into an electro-resistance-welded tube for cutting off an internal surface bead on the electro-resistance-welded tube using a cutting blade of the cutting tool; and
a support mechanism that supports the cutting tool so that the cutting tool is able to rotate substantially around a central axis of the electro-resistance-welded tube.

9. A welded tube internal bead cutting apparatus according to claim 8, wherein the cutting blade is disposed so as to face towards the rear relative to the direction in which the electro-resistance-welded tube is transported, and is formed in a circular arc shape running in an inner surface circumferential direction of the electro-resistance-welded tube.

10. A welded tube internal bead cutting apparatus according to claim 9, wherein the support mechanism has a support member that supports the cutting tool, and the cutting tool is rotated around the central axis of the electro-resistance-welded tube by rotating the support member.
